(19) United States
(12) Patent Application Publication
(10) Pub. No.: US 2010/0118180 A1
(43) Pub. Date: May 13, 2010

(54) IMAGING DEVICE

(76) Inventors: Takaki MATSUSHITA, Yokohama (JP); Akinobu Watanabe, Kawasaki (JP); Toshihiro Kato, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/611,969

(22) Filed: Nov. 4, 2009

(30) Foreign Application Priority Data
Nov. 11, 2008 (JP) 2008-288907

(51) Int. Cl. H04N 5/225

(52) U.S. Cl. 348/372; 348/E05.024

(57) ABSTRACT

The present invention provides an imaging device that reduces its power consumption and prevents an upload failure due to power insufficiency when it uploads movie content. The imaging device includes a power supply identification section which determines whether a drive power supply is a battery or an AC power supply, and a remaining battery power value acquisition section which, when a battery is employed as the drive power supply, acquires a current remaining battery power value P and compares it against a predetermined value P0. When the current remaining battery power value P is less than the predetermined value P0, an operation for movie content transmission by a communication module section is interrupted. In addition, an interruption information storage section stores the information about an interruption point of content to be interrupted.

### CLAIM OF PRIORITY

The present application claims priority from Japanese patent application serial No. JP 2008-288907, filed on Nov. 11, 2008, the content of which is hereby incorporated by reference into this application.

### BACKGROUND OF THE INVENTION

(1) Field of the Invention

The present invention relates to an imaging device that takes a motion picture and uploads it to a Web server through the Internet.

(2) Description of the Related Art

In recent years, social networking services (hereinafter referred to as SNSs), Web logs (hereinafter referred to as blogs), and other similar services are widespread and available for users to post their diaries and movie content on the Internet. These services enable the users to easily post their content by entering text, motion pictures, and other content into a dedicated form on a Web browser and uploading such content to a Web server. Similarly, movie-sharing websites and other similar services are also widespread and available for the users to share motion pictures on the Web. These services make it possible to upload movie content to a server with a dedicated form on a Web browser or movie file upload software, and allow a large indefinite number of users to share the uploaded movie content.

To use movie content on the Web, it is first necessary to take a motion picture of a subject, for instance, with a digital still camera or video camera. To upload the obtained movie content to a Web server, it is necessary to copy the content from the camera to a PC (Personal Computer) or other device connectable to the Internet, and then upload the content from the PC or the like. To provide the users with increased convenience and labor savings, however, the users should be allowed to upload the content, which is imaged by the digital still camera or video camera, directly to a Web server without having to copy the content to the PC or the like beforehand. The following has been proposed as a communication procedure used when an image is transmitted from an imaging device having a wireless communication function directly to a server or the like.

The communication procedure disclosed in JP-A-2004-289619 is to be performed when a user traveling on a train or other vehicle intends to transmit a print order from a digital camera having a wireless communication function to a photo print shop's server. This procedure includes the steps of receiving service information via a communication link, cutting off the communication, generating order information, and transmitting the order information and image data when the user reaches a communicatable area. The disclosure also indicates that the digital camera includes detection means for detecting whether the digital camera is located within a communicatable area, switches to a power saving mode when the detection means starts a detection operation, and stays in the power saving mode while the detection means is performing the detection operation.

Disclosed in JP-A-2006-197214 is a digital camera that is used in combination with a separate communication adapter having communication means. As far as removable recording means for storing shot images is connected to the communication adapter and used to transmit stored images to a server, the digital camera can perform an imaging operation even when the communication adapter is communicating with the server. The disclosure also indicates that the communication adapter checks for a command file on the server after completion of image transmission and switches to a power saving mode if no command file is found.

### SUMMARY OF THE INVENTION

The use of the technologies described in JPA-2004-289619 and JP-A-2006-197214 makes it possible to transmit a shot image from a camera or other imaging device to a desired server via a wireless LAN. Further, the devices disclosed in the above patent documents provide the communication means with a power saving mode to reduce the power consumption of the communication means.

However, the inventions disclosed in JP-A-2004-289619 and JP-A-2006-197214 assume that a still picture shot by a digital camera is transmitted to a server. When movie content, especially a motion picture shot at a full high definition 1920×1080 resolution, is transmitted to a server, an inadequate power saving effect is produced to cause a new problem. The reason is that it takes a long time to upload movie content as the file size of a motion picture is tremendously larger than that of a still picture. Therefore, the upload of a motion picture involves large power consumption, thereby imposing a great burden on a video camera which is battery-driven in most cases.

Further, if a transmission operation for uploading a motion picture file is interrupted due to power insufficiency, the transmitted file turns out to be incomplete. In such an instance, a third person may fail to download the file from the server and view it normally.

An object of the present invention is to provide an imaging device that reduces its power consumption and prevents an upload failure due to power insufficiency when it uploads movie content.

According to one aspect of the present invention, there is provided an imaging device for shooting a subject to generate picture content and transmitting the picture content to an external device, the imaging device including an imaging unit, a content storage unit, a display section, a communication module section, a power supply identification section, and a power saving mode setup section. The imaging unit shoots the subject and converts the obtained subject image to a video signal. The content storage unit stores the video signal as picture content in encoded stream format. The display section playbacks and displays the picture content. The communication module section transmits the picture content to the external device through the Internet. The power supply identification section determines whether a drive power supply is a battery or an AC power supply. The power saving mode setup section places the imaging device in a power saving mode to shut off the power supply to the communication module section when a battery is employed as the drive power supply.

According to another aspect of the present invention, there is provided an imaging device for shooting a subject to generate picture content and transmitting the picture content to an external device, the imaging device including an imaging unit, a content storage unit, a display section, a communication module section, a power supply identification section, and a remaining battery power value acquisition section. The imaging unit shoots the subject and converts the obtained subject image to a video signal. The content storage unit stores the video signal as picture content in encoded stream format. The display section playbacks and displays the picture content. The communication module section transmits the picture content to the external device through the Internet. The power supply identification section determines whether a drive power supply is a battery or an AC power supply. The remaining battery power value acquisition section acquires a current remaining battery power value P to compare it against a predetermined value P0 when a battery is employed as the drive power supply. When the current remaining battery power value P is less than the predetermined value P0, the picture content transmission operation by the communication module section is interrupted.

According to another aspect of the present invention, there is provided the imaging device, further including an interruption information storage section which stores the information about an interruption point of content to be interrupted when the transmission operation by the communication module section is to be interrupted.

According to another aspect of the present invention, there is provided the imaging device, wherein, when the information about interrupted content is stored in the interruption information storage section, the display section indicates the presence of the interrupted content; and wherein the communication module section resumes the transmission of the interrupted content from the interruption point.

According to still another aspect of the present invention, there is provided an imaging device for shooting a subject to generate picture content and transmitting the picture content to an external device, the imaging device including an imaging unit, a content storage unit, a display section, a communication module section, a power supply identification section, and a remaining battery power value prediction section. The imaging unit shoots the subject and converts the obtained subject image to a video signal. The content storage unit stores the video signal as picture content in encoded stream format. The display section playbacks and displays the picture content. The communication module section transmits the picture content to the external device through the Internet. The power supply identification section determines whether a drive power supply is a battery or an AC power supply. When a battery is employed as the drive power supply, the remaining battery power value prediction section predicts a remaining battery power value P′ prevailing upon completion of the picture content transmission and compares the predicted remaining battery power value P′ against a predetermined value P0 before the beginning of picture content transmission. When the predicted remaining battery power value P′ is less than the predetermined value P0, the display section displays information indicating that the remaining battery power is not sufficient for transmission completion.

When shot movie content is to be uploaded to a Web server, the present invention makes it possible to reduce the power consumption and prevent an upload failure due to power insufficiency.

### BRIEF DESCRIPTION OF THE DRAWINGS

The above and other features, objects, and advantages of the present invention will become more apparent from the following description when taken in conjunction with the accompanying drawings wherein:

FIG. 1 is a diagram illustrating the configuration of an exemplary content transmission system that uses an imaging device according to the present invention;

FIG. 2 is a diagram illustrating the configuration of an imaging device according to an embodiment of the present invention;

FIG. 3 is a flowchart illustrating a content upload process according to a first embodiment of the present invention;

FIG. 4 shows an example of a screen for selecting the file to be uploaded as indicated in FIG. 3;

FIG. 5 shows an example of a warning screen to be opened in step S310 of FIG. 3;

FIG. 6 is a flowchart illustrating an upload process according to a second embodiment of the present invention;

FIG. 7 is a flowchart illustrating an upload interruption process which is performed in step S608 of FIG. 6;

FIG. 8 shows an example of an upload start screen, which opens as indicated in FIG. 6;

FIG. 9 shows an example of an upload interruption screen which opens as indicated in FIG. 7;

FIG. 10 is a flowchart illustrating an upload process according to a third embodiment of the present invention;

FIG. 11 shows an example of a warning screen which opens in step S1004 of FIG. 10;

FIG. 12 is a flowchart illustrating an upload resumption process according to a fourth embodiment of the present invention; and

FIG. 13 shows an example of an upload resumption screen which opens as indicated in FIG. 12.

### DETAILED DESCRIPTION OF THE PREFERRED EMBODIMENTS

Embodiments of the present invention will now be described with reference to the accompanying drawings.

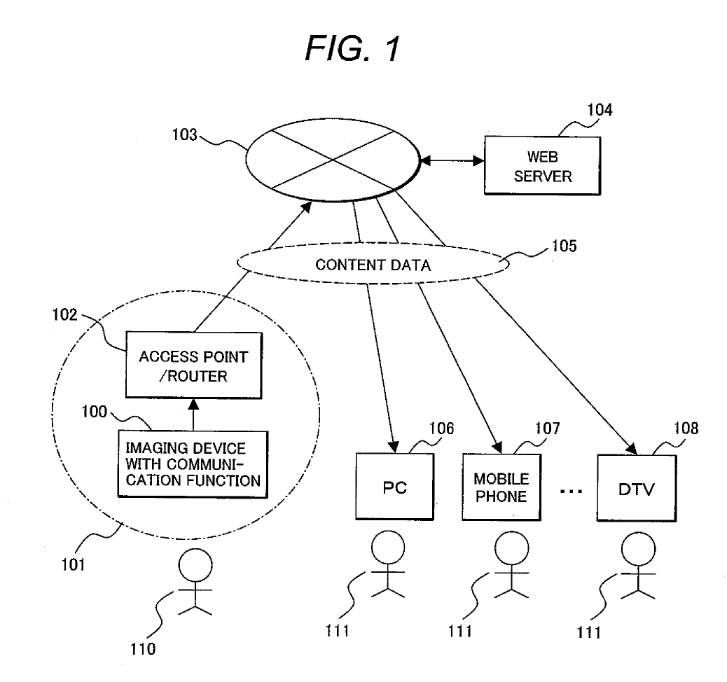

FIG. 1 is a diagram illustrating the configuration of an exemplary content transmission system that uses an imaging device according to the present invention. The system includes an imaging device 100 having a communication function, the Internet 103, a Web server 104, and an external device.

A user (movie shooter) 110 shoots a subject with the imaging device 100. The shot movie is subjected as needed to content processing. A communication function is exercised to upload the processed content data 105 to a Web server 104 (blog server or SNS server). The upload of the content data 105 is carried out by transmitting the content data 105 to the Web server 104 on the Internet 103 through an access point/router 102 in a LAN environment 101 and storing the content data 105 in the Web server 104. The LAN environment 101 may be either a wired LAN or a wireless LAN. When a wired LAN environment is used, the connection to the Internet 103 is established through a router. When, on the other hand, a wireless LAN is used, the connection to the Internet 103 is established through an access point. A user (movie viewer) 111 at a remote location accesses the Web server 104 from a PC 106, a mobile phone 107, a DTV (Digital Television) set 108, or other external device (terminal) on which a Web browser is installed. The user (movie viewer) 111 can then view the content data 105 stored in the Web server 104.

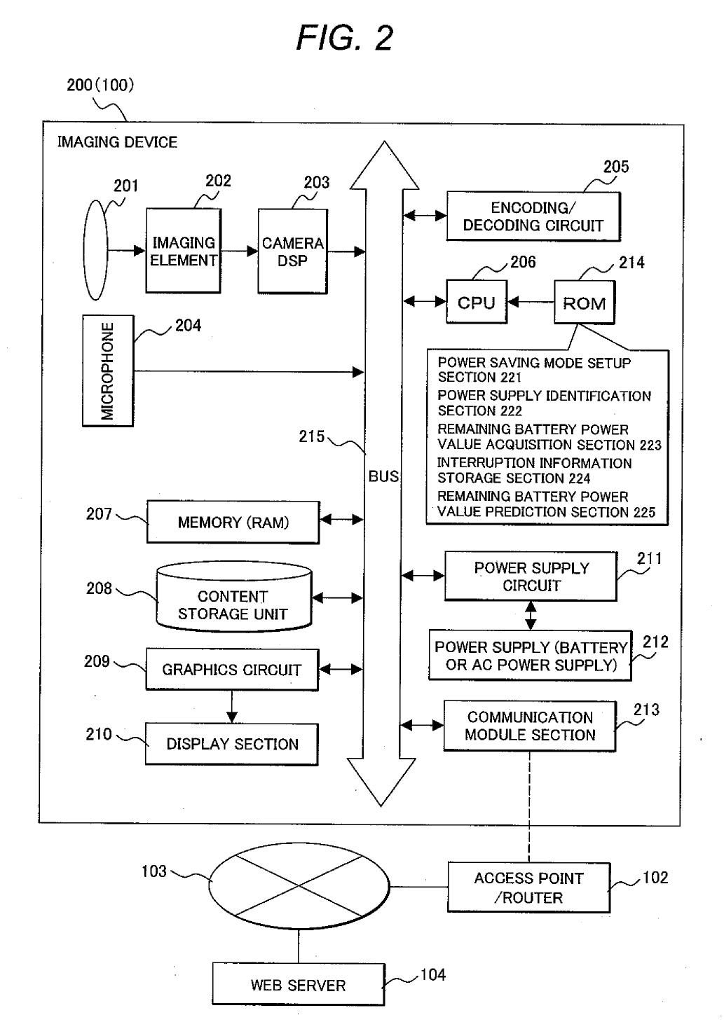

FIG. 2 is a diagram illustrating the configuration of an imaging device according to an embodiment of the present invention.

The imaging device 200 (100) includes an imaging unit which has a lens 201, an imaging element 202, a camera DSP (Digital Signal Processor) 203, and a microphone 204. To process content, the imaging device 200 (100) includes an encoding/decoding circuit 205, a CPU (Central Processing Unit) 206, a memory (RAM) 207, a content storage unit 208, a graphics circuit 209, a display section 210, and a ROM (Read Only Memory) 214. The imaging device 200 (100) also includes a power supply circuit 211, a power supply 212, and a communication module 213. These component elements are interconnected by a bus 215 and allowed to transfer data between them.

An optical signal from a subject passes through the lens 201 and is converted to an electrical signal (digital video signal) by the imaging element 202. The camera DSP 203 converts the video signal into a form acceptable to the encoding/decoding circuit 205. An audio signal from the microphone 204 passes through the bus 215 and enters the encoding/decoding circuit 205. The encoding/decoding circuit 205 generates an encoded stream in a predetermined format from the input video signal and audio signal. The content storage unit 208 stores the generated stream. The memory 207 is used as a work area for an encoding process. A hard disk drive, optical disk, semiconductor memory, or the like is employed as the content storage unit 208.

When a shot image is to be playbacked, the encoded stream stored in the content storage unit 208 is loaded into the memory 207. The encoding/decoding circuit 205 reads the stream from the memory 207 and subjects it to a decoding process. The decoded image data is passed to the graphics circuit 209 so that the display section 210 displays a playbacked image.

The communication module section 213 connects to the Internet 103 through the access point/router 102 and transmits (uploads) the image data to the Web server 104. If necessary, the stored encoded stream may be further processed before being transmitted as the image data. The data to be transmitted also includes various file transfer protocol commands.

The ROM 214 stores a program for performing the above operations. The CPU 206 controls the operations of various sections in accordance with the program. Either a battery or AC power supply may be employed as the power supply 212. The power supply circuit 211 controls the supply of power in the imaging device.

When a battery is employed as the power supply 212, the present embodiment monitors the remaining battery power to limit the power consumption. This prevents an upload failure due to insufficient power supply to the communication module section 213 during an upload. To implement the above functionality, the ROM 214 stores the following software sections. The functions of the following software sections may alternatively be implemented by hardware.

A power saving mode setup section 221 stores the information about a mode chosen by a user who places a power saving switch in either a “normal mode” or a “power saving mode”. In the “power saving mode”, a battery-powered upload is prevented to save battery power.

A power supply identification section 222 determines whether a battery or an AC power supply (AC adapter) is employed as a drive power supply. If a battery is employed as the drive power supply, the supply of power is limited.

A remaining battery power value acquisition section 223 acquires a current remaining battery power value P to compare it against a predetermined value P0. When the remaining battery power value P is less than the predetermined value P0, an upload operation is interrupted.

An interruption information storage section 224 stores the information about a point of content interruption when an upload operation is interrupted. The information about the point of interruption includes, for instance, the size of a transmitted file and the timestamp of a transmitted stream. The use of the interruption information makes it possible to smoothly resume an interrupted upload from where it has been left off (from the middle of a file).

A remaining battery power value prediction section 225 predicts a remaining battery power value prevailing upon completion of an upload before the beginning of the upload. The remaining battery power value is predicted by performing calculations on the time required for uploading the file to be transmitted and the hourly power consumption of the communication module section 213. When the predicted remaining battery power value P′ is less than the predetermined value P0, the imaging device does not start the upload, but displays a warning to indicate that the remaining battery power will be insufficient.

### First Embodiment

A content upload process according to a first embodiment of the present invention will now be described in detail. In the first embodiment, the “power saving mode” is used to save battery power. Therefore, when the imaging device is battery-driven, it prevents an upload to save battery power.

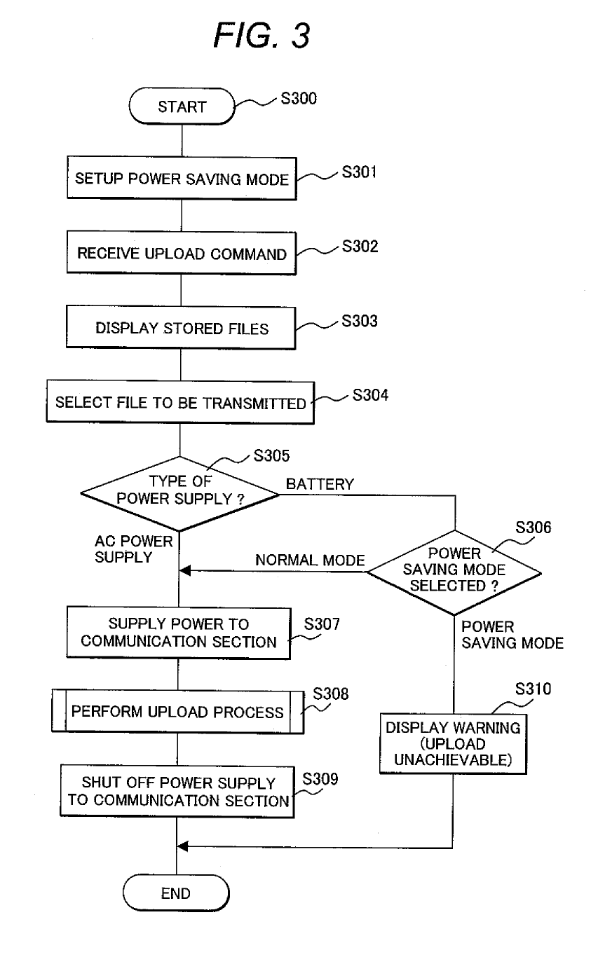

FIG. 3 is a flowchart (S300) illustrating an exemplary content upload process according to the first embodiment. It is assumed that the content storage unit 208 stores files containing image data (content) shot by a user in encoded stream format.

In step S301, the user places the power saving switch in either the “normal mode” or the “power saving mode”. The power saving mode setup section 221 then stores the information about the selected mode.

When an upload command is received from the user, step S302 is performed to switch to an upload mode. The command for switching to the upload mode is issued, for instance, by pressing an upload button or by selecting a content upload command from a GUI menu displayed on the display section 210.

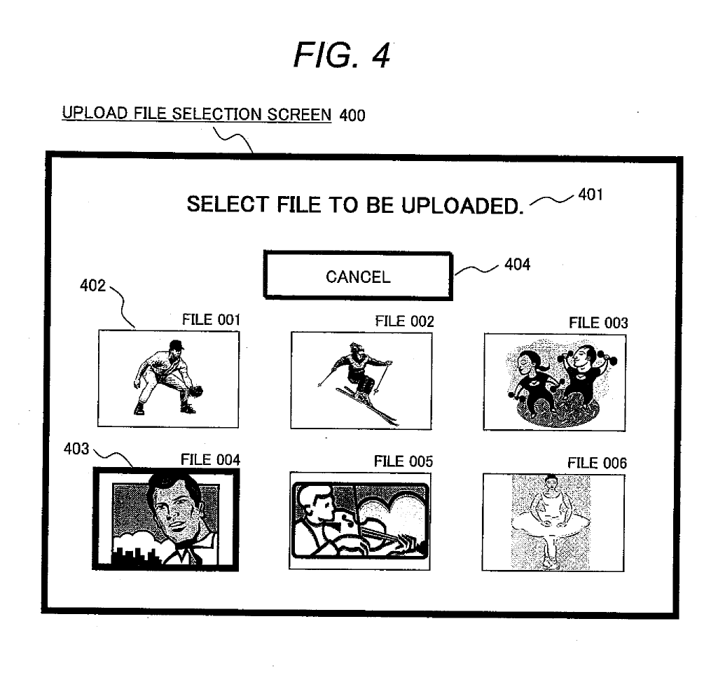

In step S303, the display section 210 displays a group of uploadable content files (FIG. 4).

In step S304, the user views the group of content files, and then selects the content file to be uploaded.

In step S305, the power supply identification section 222 determines the type of drive power supply (battery or AC power supply). When a battery is employed as the drive power supply, the imaging device proceeds to step S306. When, on the other hand, an AC power supply is employed, the imaging device proceeds to step S307.

In step S306, the power saving mode setup section 221 judges whether the power saving mode or normal mode prevails. When the power saving mode prevails, the imaging device proceeds to step S310. When, on the other hand, the normal mode prevails, the imaging device proceeds to step S307.

In step S307, the power supply circuit 211 supplies power to the communication module section 213.

In step S308, the content to be transmitted is read from the content storage unit 208, and uploaded (transmitted) from the communication module section 213 to the Web server.

In step S309, the power supply to the communication module section 213 is shut off upon completion of the upload.

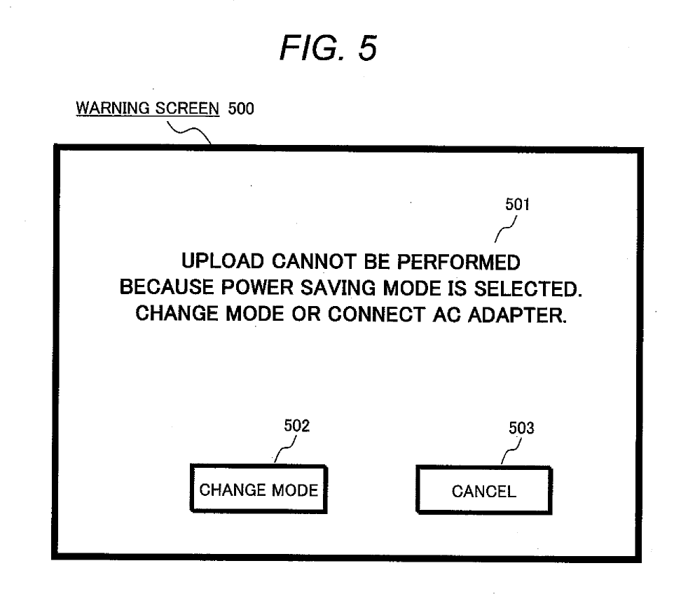

In step S310, the process terminates with a warning screen (FIG. 5) opened to indicate that the upload cannot be performed.

FIG. 4 shows an example of an upload file selection screen 400 which is used in steps S303 and S304 of FIG. 3.

A message 401 appears in the screen 400 to prompt the user to select the file to be uploaded. The screen 400 displays thumbnails 402 of pieces of content stored in the content storage unit 208. The user moves a selection border 403 to select the content file to be uploaded. FIG. 4 indicates that “file004” is chosen. To close the upload file selection screen, the user chooses a Cancel button 404.

FIG. 5 shows an example of a warning screen 500, which opens in step S310 of FIG. 3.

A message 501 appears in the screen 500 to indicate that the upload cannot be performed. The message also prompts the user to switch from the power saving mode to the normal mode or use an AC power supply (AC adapter). A Change Mode button 502 is used to switch between the power saving mode and the normal mode. To close the warning screen, the user chooses a Cancel button 503.

As described above, the first embodiment makes it possible to enter the power saving mode. When the imaging device is battery-powered in the power saving mode, it saves battery power by halting the operation of the communication module section 213, which consumes a large amount of power. Therefore, the power saving mode makes it possible to prevent an upload failure due to insufficient power supply to the communication module section 213 during an upload. The user can choose the power saving mode in consideration of shooting conditions. Further, the first embodiment makes it possible to reduce the power consumption by supplying power to the communication module section 213 only during the beginning of a content upload and shutting off the power supply to the communication module section 213 during the other period (e.g., during a shooting period).

### Second Embodiment

A second embodiment of the present invention will now be described. The second embodiment monitors the amount of remaining battery power during an upload. When the amount of remaining battery power is less than a predetermined value, the second embodiment performs an upload interruption process.

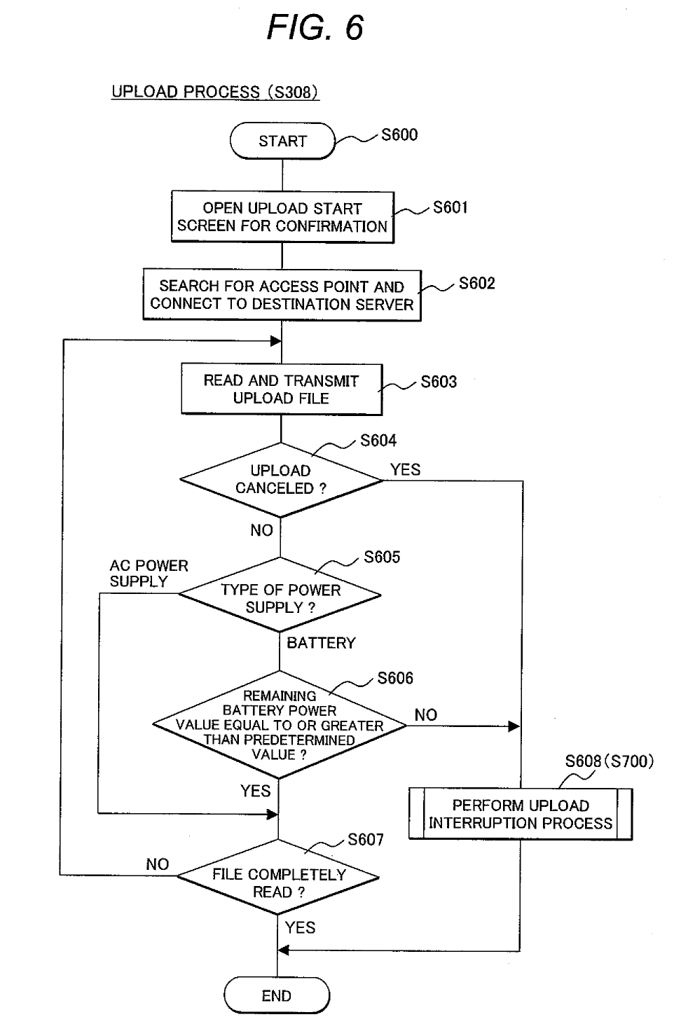

FIG. 6 is a flowchart (S600) illustrating an upload process according to the second embodiment. The upload process, which corresponds to the upload process (step S308) according to the first embodiment (FIG. 3), will now be described in detail. The other steps are the same as those of FIG. 3 and will therefore not be described here.

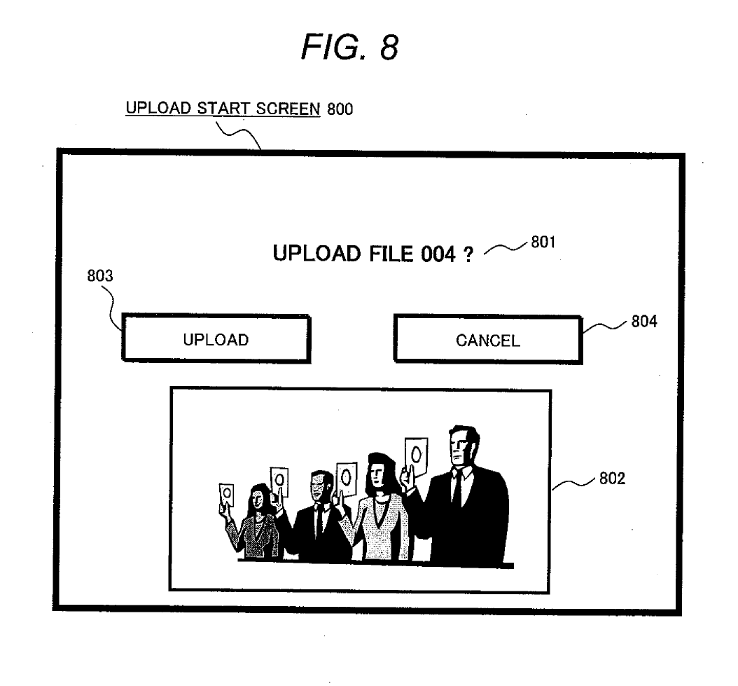

In step S601, a screen opens to ask whether the user wants to upload a selected content file (FIG. 8).

In step S602, the communication module section 213 searches for an access point 102 that is present within the range of a wireless LAN. When such an access point 102 is located, the communication module section 213 connects to a Web server 104 at a transmission destination through the Internet 103.

In step S603, the selected content file is read from the content storage unit 208. A file transfer protocol is then used to start transmitting the file to the Web server 104.

In step S604, the imaging device judges whether a cancel command has been received from the user during an upload. When such a cancel command has been received, the imaging device proceeds to step S608 and performs an upload interruption process. When, on the other hand, no such cancel command has been received, the imaging device proceeds to step S605.

In step S605, the power supply identification section 222 determines the type of drive power supply (battery or AC power supply). When a battery is employed as the drive power supply, the imaging device proceeds to step S606. When, on the other hand, an AC power supply is employed, the imaging device proceeds to step S607.

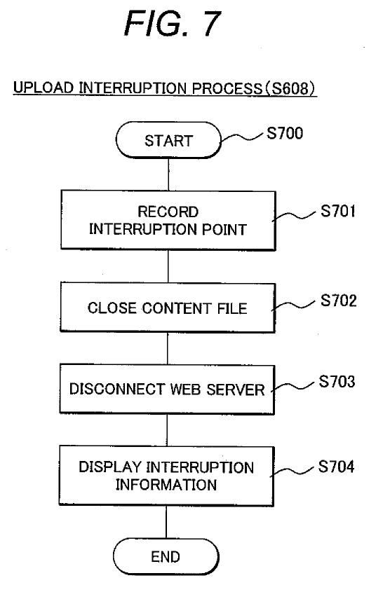

In step S606, the remaining battery power value acquisition section 223 acquires a current remaining battery power value P and compares it against a predetermined value P0. It is assumed that the predetermined value P0 represents a minimum amount of power required for performing the upload interruption process in step S608. More specifically, it is assumed that the predetermined value P0 denotes the amount of power required for smooth execution of a series of upload interruption steps (interruption point recording, file close process, Web server disconnection, and interruption information display process) shown in FIG. 7. When the remaining battery power value P is equal to or greater than the predetermined value P0, the imaging device proceeds to step S607. When, on the other hand, the remaining battery power value P is less than the predetermined value P0, the imaging device concludes that the remaining battery power is not sufficient for the completion of a content upload, proceeds to step S608, and performs the upload interruption process.

In step S607, the imaging device judges whether the file to be transmitted is completely read. When the file has not been completely read, the imaging device returns to step S603 and continues to read and transmit the file. After the file is completely read, the upload process terminates.

In step S608, the file transmission is halted to perform the upload interruption process by closing the content file. The upload interruption process will be described in detail with reference to FIG. 7.

FIG. 7 is a flowchart (S700) illustrating the upload interruption process, which is performed in step S608 of FIG. 6.

In step S701, the interruption information storage section 224 records the information about an interruption point of the content that has been uploaded. The information about the interruption point includes, for instance, the size of a transmitted file and the timestamp of a transmitted stream.

In step S702, a process is performed to close the content file that has been uploaded.

In step S703, the communication module section 213 breaks a network connection with the Web server 104.

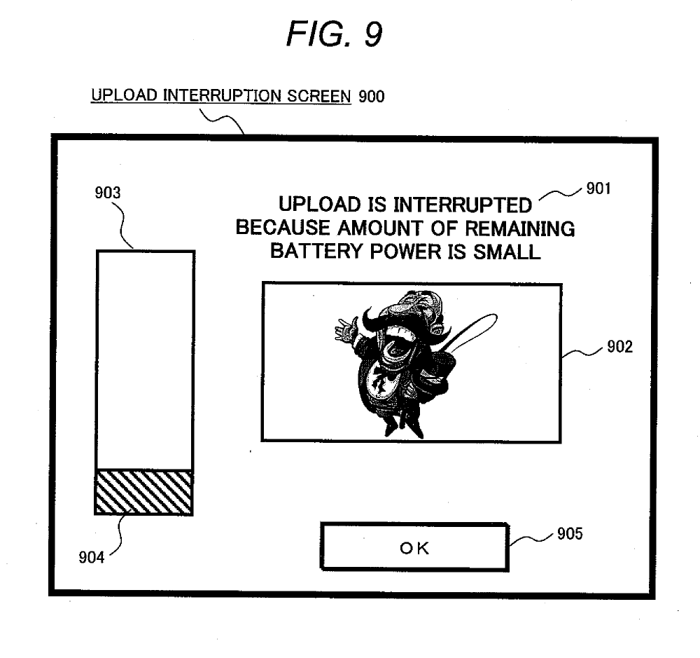

In step S704, the display section 210 opens a screen to indicate that the upload is interrupted (FIG. 9).

FIG. 8 shows an example of an upload start screen 800 which opens in step S601 of FIG. 6. A final confirmation message 801 appears in the screen 800 to ask whether the user wants to start an upload. In the example shown in FIG. 8, the message 801 asks whether the user wants to upload “file004”, with a thumbnail 802 of the file displayed. The user can perform an upload process by choosing an Upload button 803 or cancel the upload process by choosing a Cancel button 804.

FIG. 9 shows an example of an upload interruption screen 900 which opens in step S704 of FIG. 7. The screen 900 displays a message 901, a thumbnail 902 of an interruption point 902, a remaining battery power indicator 903, and an OK button 905. The message 901 indicates that an upload is interrupted because the amount of remaining battery power is small. The remaining battery power indicator 903 shows the amount of current remaining battery power 904. The user chooses the OK button 905 to recognize that the upload is interrupted. The screen 900 informs the user of an upload interruption and the reason therefor.

The second embodiment monitors the amount of remaining battery power during an upload. When the amount of remaining battery power is less than the predetermined value, the second embodiment performs the upload interruption process. This prevents the power supply to the content storage unit in the imaging device from being suddenly shut off, thereby avoiding the risk of damaging a currently accessed file. Meanwhile, a third person is allowed to unfailingly access and view the content transmitted to the Web server as far as a transmission termination process is performed normally.

Further, the second embodiment provides increased user-friendliness because it displays the information about an upload interruption to inform the user that specified content is not completely uploaded. Moreover, the second embodiment memorizes the point of upload interruption. Therefore, it is possible to ensure the integrity of a file that is incompletely uploaded to the Web server. This feature provides effective support for resuming an interrupted upload. The second embodiment is useful when movie content is to be hastily uploaded as long as battery capacity allows.

### Third Embodiment

A third embodiment of the present invention will now be described. The third embodiment estimates the amount of battery power remaining upon completion of a content upload to a Web server before the start of the content upload to perform the upload with increased certainty.

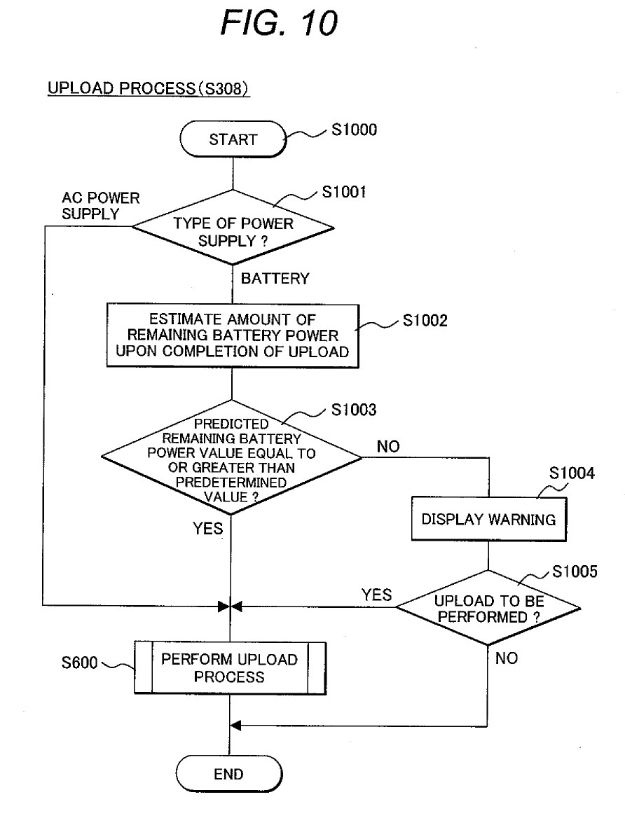

FIG. 10 is a flowchart (S1000) illustrating an upload process according to the third embodiment.

In step S1001, the power supply identification section 222 determines the type of drive power supply (battery or AC power supply). When a battery is employed as the drive power supply, the imaging device proceeds to step S1002. When, on the other hand, an AC power supply is employed, the imaging device proceeds to step S600 of FIG. 6 and starts performing the upload process.

In step S1002, the remaining battery power value prediction section 225 estimates the amount of battery power remaining upon completion of an upload. The amount of remaining battery power can be estimated by determining upload time from a content transfer rate and the size of the file to be uploaded and performing a calculation on the hourly power consumption of the communication module section 213.

In step S1003, the predicted remaining battery power value P′ is compared against a predetermined value P0. It is also assumed that the predetermined value P0 includes the amount of power required for the upload interruption process. When the predicted remaining battery power value P is equal to or greater than the predetermined value P0, the imaging device proceeds to step S600 and starts performing the upload process. When, on the other hand, the predicted remaining battery power value P is less than the predetermined value P0, the imaging device proceeds to step S1004.

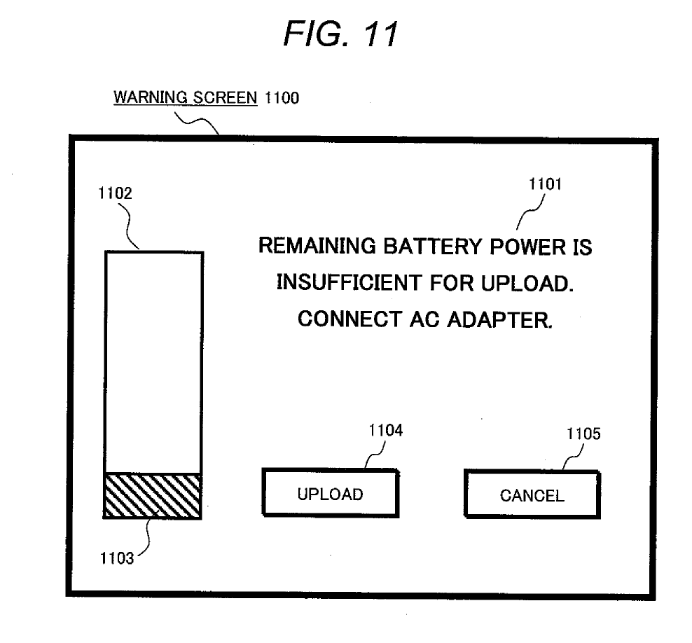

In step S1004, the imaging device does not start performing the upload process, but opens a warning screen (FIG. 11) to warn the user that the predicted battery power remaining upon completion of an upload is insufficient.

In step S1005, the imaging device receives a user's response to the warning. When the user instructs the imaging device to cancel the upload, the imaging device terminates its operation without performing the upload process. When, on other hand, the user reinstructs the imaging device to perform the upload process although the predicted remaining battery power is insufficient, the imaging device is forced to perform the upload process in step S600.

In the upload process (step S600) shown in FIG. 6, the current remaining battery power is monitored (step S606) even after the start of an upload to perform the upload interruption process if the amount of remaining battery power is too small. Therefore, the upload process will be completed without fail.

FIG. 11 shows an example of a warning screen 1100, which opens in step S1004 of FIG. 10. The screen 1100 displays a warning message 1101, a remaining battery power indicator 1102 for indicating battery usage, an Upload button 1104, and a Cancel button 1105. The warning message 1101 indicates that the amount of remaining battery power is insufficient for completing the upload of the selected content. The warning message 1101 also prompts the user to connect an AC power supply (AC adapter) as an alternative power supply. The remaining battery power indicator 1102 shows the amount of predicted remaining battery power 1103, thereby permitting the user to grasp the predicted power consumption of the battery. When the user chooses the Cancel button 1105, the imaging device terminates its operation without performing the upload. When, on other hand, the user chooses the Upload button 1104, the imaging device is forced to perform the upload no matter whether the remaining battery power is insufficient for the completion of the upload.

The third embodiment determines whether or not to start a process by estimating the amount of battery power remaining upon completion of an upload before its start. Therefore, the third embodiment can perform the upload with increased certainty without encountering a situation where the available power becomes suddenly insufficient during the upload. Further, the third embodiment displays the information about battery power insufficiency beforehand, thereby allowing the user to form an appropriate judgment as to whether the user, depending on the prevailing situation, should switch to the AC power supply or force the imaging device to initiate the upload process. This feature provides increased user-friendliness.

Moreover, using the third embodiment in conjunction with the second embodiment makes it possible to prevent an upload failure even if the imaging device is forced to initiate the upload process when the amount of predicted remaining battery power is less than the predetermined value. The reason is that the imaging device can interrupt the upload process and display the information about the upload interruption when the amount of battery power remaining during the upload process is close to the predetermined value.

### Fourth Embodiment

A fourth embodiment of the present invention will now be described. The fourth embodiment properly resumes an interrupted content upload when performing an upload start process subsequently to upload interruption by the second embodiment. It should be noted that the upload interruption process (S700) is performed as shown in FIG. 7 to record, in the interruption information storage section 224, the information about an interruption point of content.

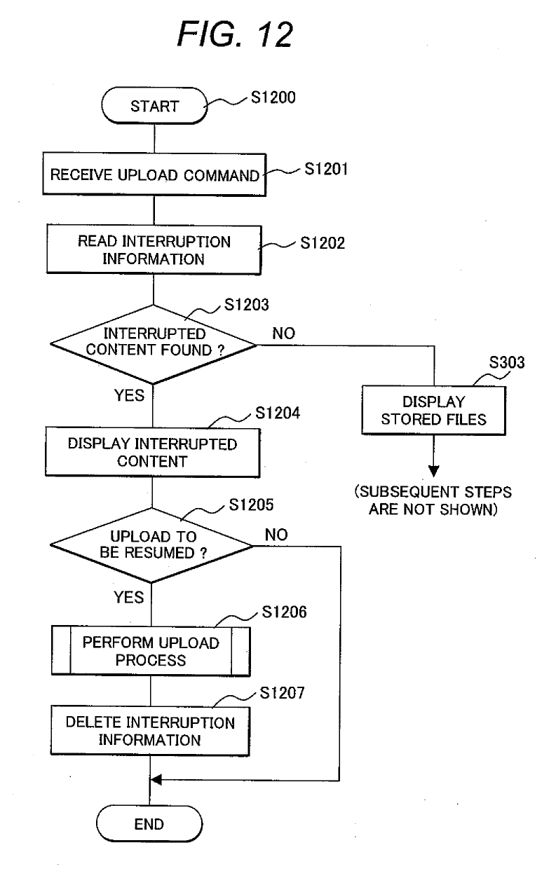

FIG. 12 is a flowchart (S1200) illustrating an upload resumption process that is performed on content whose upload has been interrupted.

In step S1201, an upload command is received from the user.

In step S1202, the information about content whose upload has been interrupted is read from the interruption information storage section 224.

In step S1203, the read information is used to judge whether there is interrupted content. When there is interrupted content, the imaging device proceeds to step S1204. When, on the other hand, there is no interrupted content, the imaging device performs a normal upload process. More specifically, the imaging device proceeds to step S303 of FIG. 3, displays stored content files for selection, and uploads a selected content file.

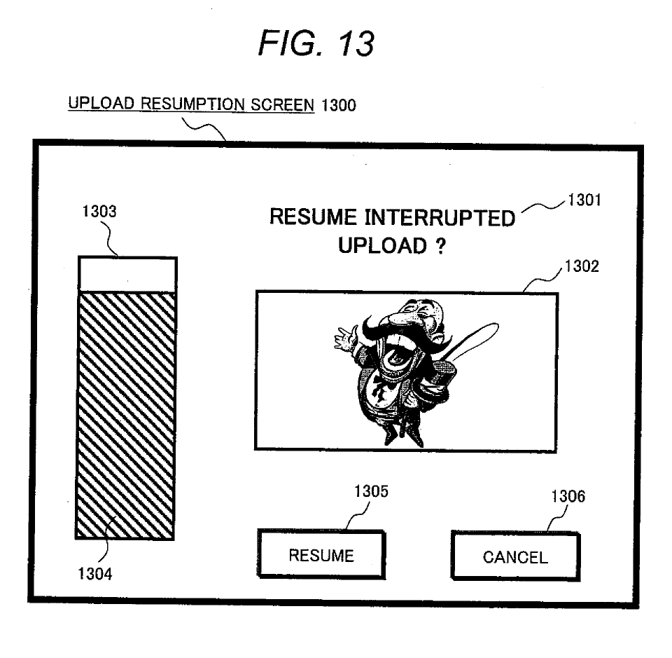

In step S1204, the imaging device displays a thumbnail of interrupted content (FIG. 13). When there are a plurality of pieces of interrupted content, the imaging device displays a list of their thumbnails.

In step S1205, the user is prompted to select the content whose upload is to be resumed. When the user cancels the upload resumption process, the imaging device terminates its operation without performing anything. When, on the other hand, the user chooses to resume the upload, the imaging device proceeds to step S1206.

In step S1206, the communication module section 213 resumes the upload of interrupted content from the point of interruption. Here, the upload process is performed in the same manner as that in steps S305 and beyond of FIG. 3.

Step S1207 is performed upon completion of the upload process to delete the information about the interrupted content from the interruption information storage section 224.

FIG. 13 shows an example of an upload resumption screen 1300 which opens in step S1204 of FIG. 12. The screen 1300 displays a resumption message 1301, a thumbnail 1302 of a resumption point, a remaining battery power indicator 1303, the amount of current remaining battery power 1304, a Resume button 1305, and a Cancel button 1306. The message 1301 informs the user that there is content whose upload has been interrupted, and prompts the user to resume its upload. The user chooses the Resume button 1305 to resume the upload or chooses the Cancel button 1406 to cancel the upload.

When there is any content whose upload has been interrupted, the fourth embodiment automatically informs the user of it and prompts for the resumption of its upload. Therefore, even when the user is not aware of content whose upload has been interrupted, the fourth embodiment enables the user to resume its upload unfailingly and smoothly.

The configurations and processes of the above-described embodiments are merely illustrative. Further, the features provided by the individual embodiments can be combined as needed.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An imaging device for shooting a subject to generate picture content and transmitting the picture content to an external device, the imaging device comprising:
an imaging unit which shoots the subject and converts the obtained subject image to a video signal;
a content storage unit which stores the video signal as picture content in encoded stream format;
a display section which playbacks and displays the picture content;
a communication module section which transmits the picture content to the external device through the Internet;
a power supply identification section which determines whether a drive power supply is a battery or an AC power supply; and
a power saving mode setup section which places the imaging device in a power saving mode to shut off the power supply to the communication module section when a battery is employed as the drive power supply.

2. An imaging device for shooting a subject to generate picture content and transmitting the picture content to an external device, the imaging device comprising:
an imaging unit which shoots the subject and converts the obtained subject image to a video signal;
a content storage unit which stores the video signal as picture content in encoded stream format;
a display section which playbacks and displays the picture content;
a communication module section which transmits the picture content to the external device through the Internet;
a power supply identification section which determines whether a drive power supply is a battery or an AC power supply; and
a remaining battery power value acquisition section which acquires a current remaining battery power value P and comparing the acquired value against a predetermined value P0 when a battery is employed as the drive power supply;
wherein, when the current remaining battery power value P is less than the predetermined value P0, an operation for the picture content transmission by the communication module section is interrupted.

3. The imaging device according to claim 2,
wherein, when the transmission operation by the communication module section is to be interrupted, the display section displays information indicating that the transmission operation will be interrupted due to the insufficiency of remaining battery power.

4. The imaging device according to claim 2, further comprising an interruption information storage section which stores the information about an interruption point of content to be interrupted when the transmission operation by the communication module section is to be interrupted.

5. The imaging device according to claim 4,
wherein, when the information about interrupted content is stored in the interruption information storage section, the display section indicates the presence of the interrupted content; and
wherein the communication module section resumes the transmission of the interrupted content from the interruption point.

6. An imaging device for shooting a subject to generate picture content and transmitting the picture content to an external device, the imaging device comprising:
an imaging unit which shoots the subject and converts the obtained subject image to a video signal;
a content storage unit which stores the video signal as picture content in encoded stream format;
a display section which playbacks and displays the picture content;
a communication module section which transmits the picture content to the external device through the Internet;
a power supply identification section which determines whether a drive power supply is a battery or an AC power supply; and
a remaining battery power value prediction section which, when a battery is employed as the drive power supply, predicts a remaining battery power value P′ prevailing upon completion of the picture content transmission and compares the predicted remaining battery power value P′ against a predetermined value P0 before the beginning of the picture content transmission;
wherein, when the predicted remaining battery power value P′ is less than the predetermined value P0, the display section displays information indicating that the remaining battery power is not sufficient for transmission completion.

7. The imaging device according to claim 6, wherein, when the predicted remaining battery power value P′ is less than the predetermined value P0, the display section displays the predicted remaining battery power value P′ and information prompting for connection to the AC power supply.
